(19) United States
(12) Patent Application Publication
(10) Pub. No.: US 2016/0378249 A1
(43) Pub. Date: Dec. 29, 2016

(54) INPUT DEVICE, DISPLAY APPARATUS AND TERMINAL APPARATUS

(71) Applicant: Kabushiki Kaisha Toshiba, Minato-ku (JP)

(72) Inventors: Kentaro MIURA, Kawasaki (JP); Hajime YAMAGUCHI, Kawasaki (JP); Tatsunori SAKANO, Kawasaki (JP); Tomomasa UEDA, Yokohama (JP); Nobuyoshi SAITO, Tokyo (JP); Shintaro NAKANO, Kawasaki (JP)

(73) Assignee: Kabushiki Kaisha Toshiba, Minato-ku (JP)

(21) Appl. No.: 15/261,065

(22) Filed: Sep. 9, 2016

Related U.S. Application Data
(63) Continuation of application No. PCT/JP2015/053626, filed on Feb. 10, 2015.

(30) Foreign Application Priority Data
Mar. 19, 2014 (JP) 2014-056257

(51) Int. Cl. G06F 3/041; G06F 3/044

(52) U.S. Cl. CPC G06F 3/0416; G06F 3/044; G06F 3/0412; G06F 2203/04102; G02F 1/13338

(57) ABSTRACT

According to an embodiment, an input device includes the following elements. The flexible touch panel includes a sensor area. The touch position detector detects a touch position on the sensor area to generate a detection signal. The deformation position detector detects a deformation position where a deformation amount is not less than a threshold on the sensor area. The input rejection area determination unit determines, based on the deformation position, an input rejection area. The input signal generator fails to output the detection signal as an input signal if the touch position is detected in the input rejection area, and outputs the detection signal as an input signal if the touch position is detected in an area other than the input rejection area.

### CROSS-REFERENCE TO RELATED APPLICATIONS

This application is a Continuation Application of PCT Application No. PCT/JP2015/053626, filed Feb. 10, 2015 and based upon and claiming the benefit of priority from Japanese Patent Application No. 2014-056257, filed Mar. 19, 2014, the entire contents of all of which are incorporated herein by reference.

### FIELD

Embodiments described herein relate generally to an input device, and a display apparatus and a terminal apparatus which employ the input device.

### BACKGROUND

A flexible display is advantageous in that it is thin, light in weight and unbreakable. It is a display apparatus suitable for use in such mobile terminal apparatuses as a cell phone, a smart phone, a laptop personal computer (PC) and a tablet terminal. Mobile terminal apparatuses are required to be thin and light in weight, and the use of a flexible display can satisfy the requirement. Unlike the conventional terminal apparatuses, a mobile terminal apparatus employing a flexible display is not very rigid and may easily deform. At the same time, however, the flexible terminal apparatus deforms in accordance with the shape of the hand which holds it, and can therefore be easy to hold. It is proposed to use such a flexible terminal device as an input device.

In recent years, a narrow-frame display is in wide use, in which the peripheral portions of the display are designed to be as narrow as possible so that the display area can be as wide as possible. However, if the portable terminal apparatus has an increased display area by employing such a narrow-frame display, incorrect input is likely to happen due to the fingers with which to hold the portable terminal, apparatus.

### BRIEF DESCRIPTION OF DRAWINGS

FIG. 1 is a block diagram illustrating an input device according to the first embodiment.

FIG. 2A illustrates how the touch panel depicted in FIG. 1 is held by the left hand of a user.

FIG. 2B illustrates an operation in which the input signal generator depicted in FIG. 1 generates an input signal.

FIG. 3A is a plan view illustrating an example of a portable terminal apparatus employing the input device depicted in FIG. 1.

FIG. 3B is a sectional view of the portable terminal apparatus depicted in FIG. 3A.

FIGS. 4A, 4B, 4C, 4D and 4E illustrate examples of how a bending sensor employed in the embodiment is arranged.

FIGS. 5A and 5B are sectional views of the bending sensor depicted in FIG. 1.

FIGS. 6A, 6B, 6C and 6D are sectional views illustrating examples of how the bending sensor depicted in FIG. 1 is arranged when it is provided for a touch panel.

FIGS. 7A and 7B are diagrams illustrating a method in which a radius-of-curvature threshold is derived according to the embodiment.

FIG. 8 shows an example of an input rejection area set on the touch panel depicted in FIG. 1.

FIG. 9A shows another example of an input rejection area set on the touch panel depicted in FIG. 1.

FIGS. 9B and 9C illustrate states in which the side portion of the touch panel depicted in FIG. 1 is held with a hand of a user.

FIG. 10A shows another example of an input rejection area set on the touch panel depicted in FIG. 1.

FIG. 10B illustrates a state in which the lower portion of the touch panel depicted in FIG. 1 is held with a hand of a user.

FIGS. 11 and 12 show other examples of an input rejection area set on the touch panel depicted in FIG. 1.

FIG. 13 is a block diagram illustrating an input device according to a modification of the first embodiment.

FIG. 14 illustrates an operation which the input signal generator depicted in FIG. 13 generates an input signal.

FIG. 15 is a block diagram illustrating an input device according to the second embodiment.

FIGS. 16A, 16B, 16C, 16D, 16E and 16F are sectional views illustrating examples of positional relationships among the touch panel, display panel and bending sensor depicted in FIG. 15.

FIGS. 17A, 17B and 17C illustrate examples in which an image is displayed on the display panel depicted in FIG. 15, except on the input rejection area.

FIG. 18 is a block diagram illustrating an input device according to the third embodiment.

### DETAILED DESCRIPTION

According to an embodiment, an input device includes a flexible touch panel, a touch position detector, a deformation position detector, an input rejection area determination unit, and an input signal generator. The touch panel includes a sensor area which is to be touched by an object. The touch position detector detects a touch position on the sensor area to generate a detection signal. The deformation position detector detects a deformation position where a deformation amount is not less than a threshold on the sensor area. The input rejection area determination unit determines, based on the deformation position, an input rejection area where an input is rejected on the sensor area. The input signal generator processes the detection signal based on the touch position detected by the touch position detector and the input rejection area determined by the input rejection area determination unit, wherein the input signal generator fails to output the detection signal as an input signal if the touch position is detected in the input rejection area, and outputs the detection signal as an input signal if the touch position is detected in an area other than the input rejection area.

Hereinafter, embodiments will be described with reference to the drawings. In the embodiments set forth below, like elements will be denoted by like reference numerals, and redundant descriptions will be omitted where appropriate. The drawings are schematic and do not exactly show the relationships between thicknesses and plan dimensions or ratios among the thicknesses of the layers. In addition, the dimensional relationships and ratios shown in one Figure may be shown differently in another Figure.

### First Embodiment

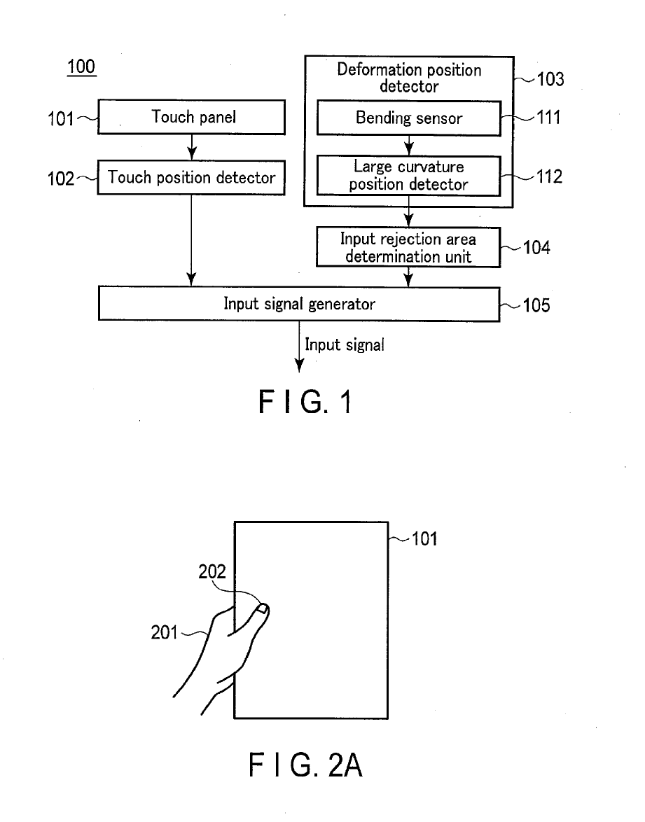

FIG. 1 schematically shows an input device 100 according to the first embodiment. As shown in FIG. 1, the input device 100 includes a touch panel (also called a touch-sensitive panel) 101 being flexible, a touch position detector 102, a deformation position detector 103, an input rejection area determination unit 104 and an input signal generator 105.

The touch panel 101 detects an object (for example, a user's finger or stylus pen) touching on the sensor area thereof to generate a sensor signal. In the present embodiment, the touch panel 101 is a capacitive type and can detect touches (contacts) at two or more points. The touch panel 101 is not limited to a capacitive type and may be any type. In the following, reference will be made to the case where the user performs an input operation, using his or her finger. The touch position detector 102 detects a touch position on the sensor area based on the detection signal received from the touch panel 101 and generates a detection signal. The touch position indicates a position where the object has touched the sensor area.

The touch panel 101 deforms, for example, when the user holds it with a hand. The area on the touch panel 101 which is touched by the hand of the user to hold the touch panel 101 will be referred to as a holding area. The deformation position detector 103 detects which position of the touch panel 101 deforms more than a predetermined threshold (the position will be referred to as a deformation position). In the present embodiment, a curvature or a radius of curvature is used as an index indicative of a deformation amount. The radius of curvature is defined as a reciprocal of the curvature. The deformation position detector 103 detects a position whose curvature is, not less than a predetermined curvature threshold, as a deformation position. In other words, the deformation position detector 103 detects a position whose radius of curvature is not more than a predetermined radius-of-curvature threshold, as the deformation position (the radius-of-curvature threshold is a reciprocal of the curvature).

Specifically, the deformation position detector 103 includes a bending sensor 111 and a large curvature position detector 112. The bending sensor 111 generates sensor signals in accordance with deformation amounts at a number of positions on the touch panel 101. The bending sensor 111 is, for example, a resistive type sensor whose resistance changes when it is deformed or bent. The bending sensor 111 may be another type of sensor, such as a capacitive type or a pressure-sensitive type. The bending sensor 111 is provided for the entire touch panel 101 or part of the touch panel 101. The bending sensor 111 deforms in accordance with the deformation of the touch panel 101. The large curvature position detector 112 calculates curvatures at the respective positions on the touch panel 101 based on the resistance changes of the bending sensor 111, and detects a position whose curvature is not less than the curvature threshold as a deformation position. Alternatively, the position where the curvature is largest may be defined as a deformation position. The position where the curvature is largest and not less than the curvature threshold may be defined as a deformation position. The large curvature position detector 112 supplies, to the input rejection area determination unit 104, deformation position information indicating the deformation position and a deformation amount (a curvature in this embodiment) at the deformation position.

The input rejection area determination unit 104 determines, based on the deformation position information received from the deformation position detector 103, an input rejection area (also called an inactive area) in the sensor area of the touch panel 101. In the present embodiment, if a number of deformation positions are detected, one input rejection area may be set based on the position where the deformation amount is largest. In an alternative embodiment, a number of input rejection areas may be set. In the sensor area, the areas other than the input rejection area will be referred to as an input area. A method for setting an input rejection area will be described later.

Even if a detection signal is generated based on a touch detected in the input rejection area of the touch panel, the input signal generator 105 does not output this detection signal as an input signal. For example, the input signal generator 105 discards a detection signal generated based on a touch detected in the input rejection area. The input signal generator 105 output, as an input signal, a detection signal being based on a touch detected in the input area of the touch panel 101. The input signal generator 105 determines that the touch detected in the input area of the touch panel 101 as an intended input by the user and that the touch detected in the input rejection area of the touch panel 101 as an unintended input by the user.

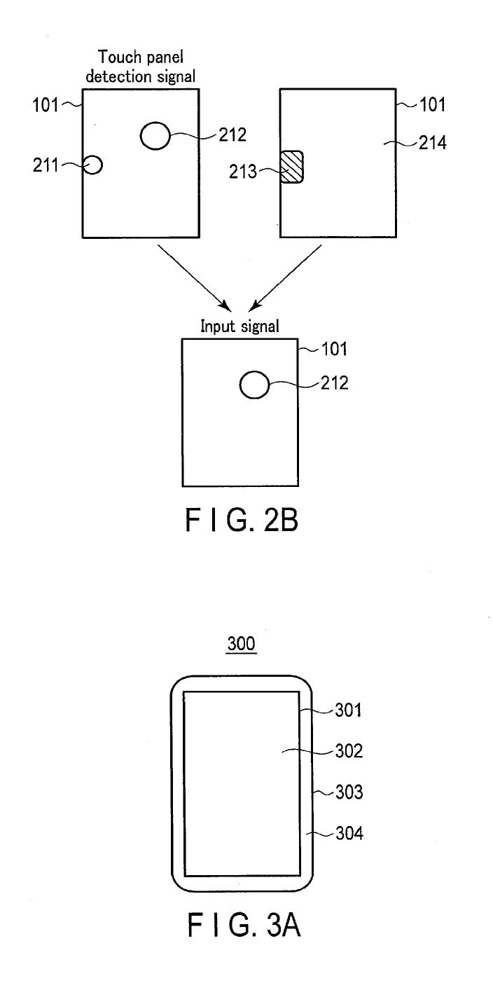

For example, the user holds the touch panel 101 with his or her left hand 201, as shown in FIG. 2A. The thumb 202 of the left hand 201 is on the surface of the touch panel 101 which includes the sensor area, and the fingers of the left hand 201 are on the reverse side of the touch panel 101. The touch panel 101 deforms greatly at the portion held with the left hand 201. As a result, as shown in FIG. 2B, a portion 213 corresponding to the touch 211 by the thumb 202 of the left hand 201 is set as an input rejection area. If, in this state, the user performs a touch operation with his or her right hand, two touches are detected, namely, the touch 211 by the left hand and the touch 212 by the right hand. Since the position of touch 211 is in the input rejection area 213, the detection of touch 211 is ignored, and an input signal is generated based on the touch 212 detected in the input area 214. Since the detection of the touch in the input rejection area is ignored, incorrect input caused by the hand holding the input device 100 is prevented.

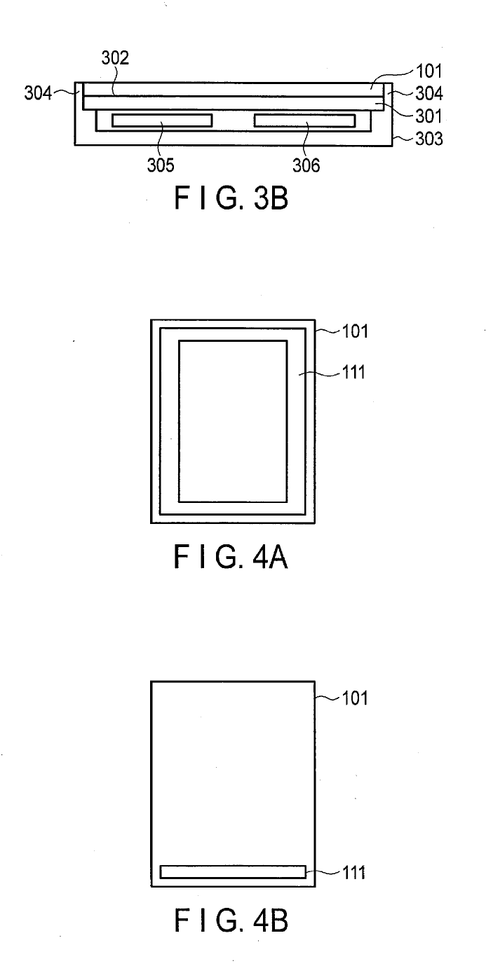

Typically, the input device 100 shown in FIG. 1 is used in combination with a flexible display. By this combination, a flexible mobile terminal apparatus can be realized. FIGS. 3A and 3B are a plan view and a sectional view, respectively, and schematically illustrate a flexible mobile terminal apparatus 300 provided with an input device 100. In the mobile terminal apparatus 300 shown in FIG. 3A, the touch panel 101 of the input device 100 is opposed to the display screen 302 of the display 301, as shown in FIG. 3B. The touch panel 101 is transparent so that the user can visually recognize what is displayed on the display screen 302. The touch panel 101 and the display apparatus 301 are secured to a casing 303 and supported thereby. The casing 303 is a thin box-like member and accommodates such electronic elements as a processor 305 and a battery 306. In order to provide a display area which is as wide as possible, the frame 304 of the casing 303 is narrow. When the mobile terminal apparatus 300 is held by the user, a finger of the user may touch the sensor area of the touch panel 101.

The mobile terminal apparatus 300 is elastically deformable when external force is applied thereto. For example, when the mobile terminal apparatus 300 is held by a hand of the user, it may deform in accordance with the shape of the hand. When the deformation amount of the touch panel 101 exceeds a threshold, an input rejection area is set in the sensor area. Normally, the deformation amount becomes largest at the portion where the finger holding the apparatus 300 is located, and an area including that portion is set as an input rejection area. Therefore, incorrect input caused by the finger holding the apparatus 300 is prevented. If the mobile terminal apparatus 300 is not rigid, the user holds the apparatus 300 at an inward portion. The present embodiment can prevent incorrect input in this case as well.

In the following, descriptions will be given on the assumption that the input device 100 is provided for the mobile terminal apparatus.

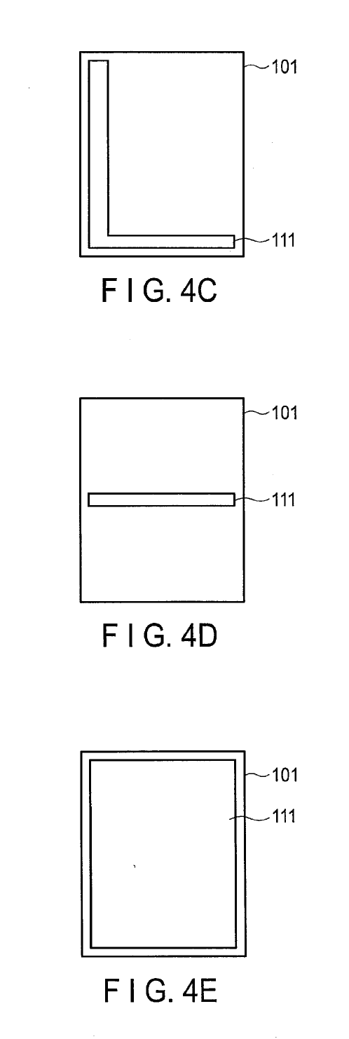

A description will be given as to how the bending sensor 111 is arranged. Desirably, the bending sensor 111 is provided for an area which is likely to be touched by a finger holding the mobile terminal apparatus. For example, the bending sensor 111 is provided along the periphery of the sensor area, as shown in FIG. 4A. By way of example, the touch panel 101 has a rectangular planar shape, and the bending sensor 11 is arranged along the four sides of the sensor area. For example, the bending sensor 111 surrounds the sensor area. In other words, the sensor area is an inside portion surrounded by the bending sensor 111.

If the touch panel 101 is used in a limited situation, the bending sensor 111 may be arranged at part of the periphery of the sensor area. For example, the bending sensor 111 may be arranged along one side of the sensor area, as shown in FIG. 4B; alternatively, it may be arranged along two sides of the sensor area, as shown in FIG. 4C. The two sides may be adjacent to each other, as shown in FIG. 4C, or may be opposite to each other. In addition, the bending sensor 111 may be arranged in the center of the sensor area of the touch panel 101, as shown in FIG. 4D. Further, the bending sensor 111 may be provided on the entire sensor area of the touch panel 101, as shown in FIG. 4E. From the standpoint of prevention of incorrect input caused by a finger holding the mobile terminal apparatus, the bending sensor 111 located around the touch panel 101 suffices. Where the bending sensor 111 is arranged for two or more sides of the touch panel 101, the position where the user's finger is touched can be detected with high accuracy.

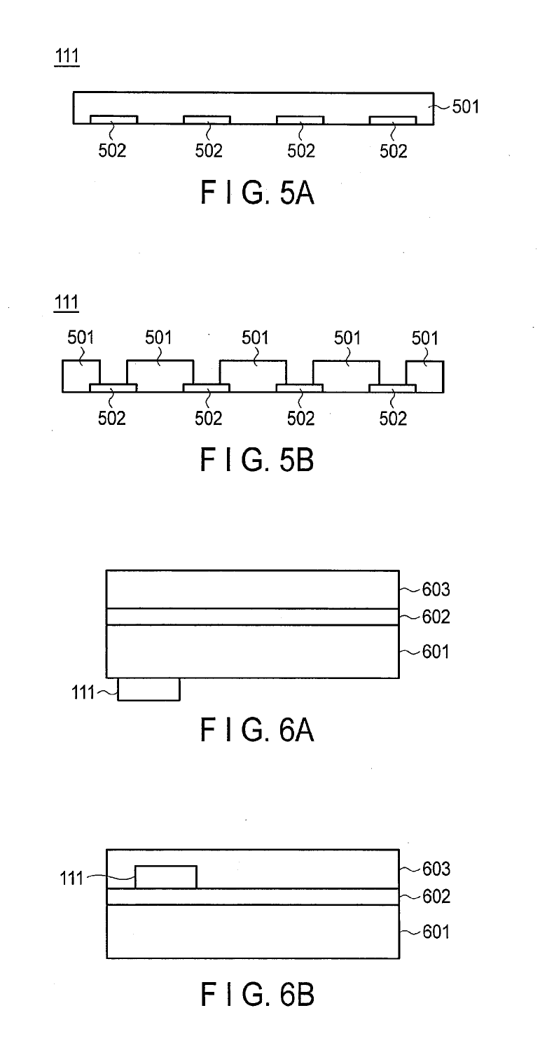

FIG. 5A illustrates an example of a resistive type bending sensor 111. As shown in FIG. 5A, the bending sensor 111 includes a conductive film 501 whose resistance changes when it is deformed, and a plurality of electrodes 502 for detecting the resistance of the conductive film 501. The electrodes 502 are arranged at regular intervals (e.g., at intervals of 10 mm), and the conductive film 501 covers these electrodes 502. The electrodes 502 are, for example, linear and are arranged side by side such that they extend in the same direction. The electrodes 502 are provided, for example, in a matrix pattern. The curvature at a given position of the touch panel 101 can be calculated based on the resistance change between adjacent electrodes 502. As shown in FIG. 5B, the conductive film 501 may be provided in such a manner as to electrically connect the adjacent two electrodes 502.

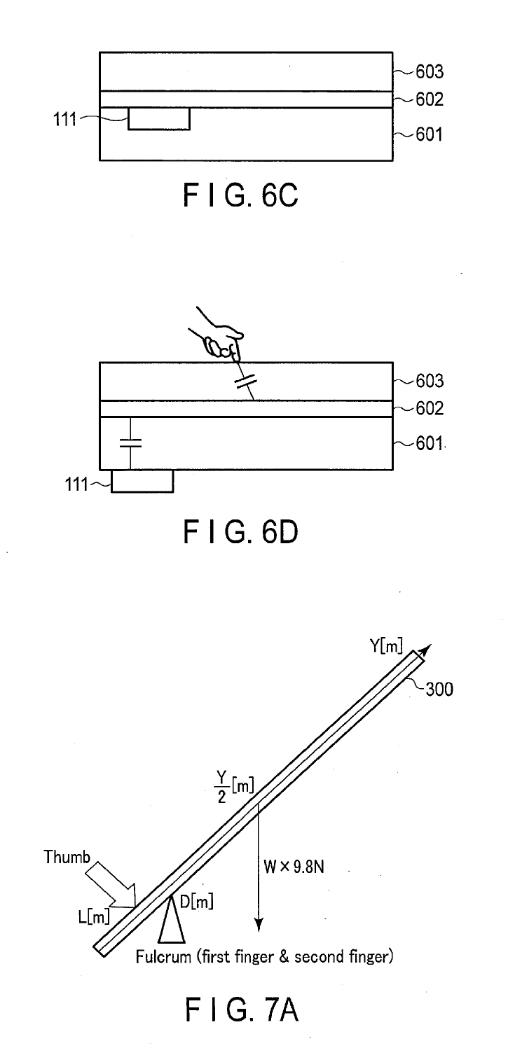

FIGS. 6A to 6D illustrates examples of how the bending sensor 111 is arranged in a cross section of the touch panel 101. As shown in FIG. 6A, the touch panel 101 includes a touch panel substrate 601, a plurality of detection electrodes 602 arranged on the touch panel substrate 601, and a protective layer 603 formed on the touch panel 601 in such a manner as to cover the detection electrodes 602. In FIG. 6A, the detection electrodes are depicted as one layer, for simplicity. In the example shown in FIG. 6A, the bending sensor 111 is attached to a surface of the touch panel substrate 601 (the surface is opposite to that on which the detection electrodes 602 are arranged).

In the example shown in FIG. 6B, the bending sensor 111 is located between the detection electrodes 602 and the protective layer 603. In the example shown in FIG. 6C, the bending sensor 111 is located between the touch panel substrate 601 and the detection electrodes 602. In the examples shown in FIGS. 6B and 6C, the bending sensor 111 can be electrically connected to a leading line which is formed simultaneously with the detection electrodes 602 of the touch panel 101. Part of a wiring line of the touch panel 101 may be used as part of the wiring line of the bending sensor 111. In the example shown in FIG. 6D, the bending sensor 111 is a capacitive type sensor which detects a capacitance between an electrode formed simultaneously with the detection electrodes 602 of the touch panel 101 and an electrode parallel to that electrode. When the touch panel 101 deforms, the distance between the electrodes shortens, and the capacitance changes, accordingly. The deformation amount of the touch panel 101 is calculated based on this capacitance change.

A description will be given of thresholds used for the detection of a deformation position.

In the following, it is assumed that the touch panel 101 is held with one hand of the user, as shown in FIG. 2A. In this case, the touch panel 101 deforms in accordance with the shape of the thumb. In general, the radius of curvature of the side of the thumb of an adult is 50 mm or so. Therefore, the radius-of-curvature threshold can be set at 50 mm, for example.

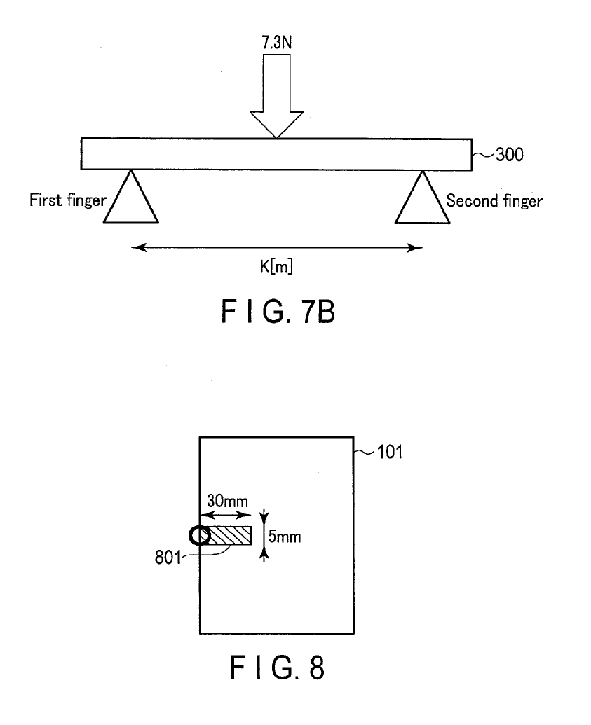

In another example, the radius-of-curvature threshold may be determined based on the weight of the mobile terminal apparatus, the thickness of the touch panel 101, etc. Let us assume here that the terminal apparatus weighs W [kg] and has a size of X [m]×Y [m]. Let us also assume that the mobile terminal apparatus 300 is held from below the touch panel 10 with one hand of the user in the manner shown in FIG. 7A. To be specific, the thumb touches the front surface of the mobile terminal apparatus 300 at a position L [m] away from the lower end of the mobile terminal apparatus 300, the first and second fingers touch the rear surface of the mobile terminal apparatus 300 at a position D [mm] away from the lower end of the mobile terminal apparatus 300, and the mobile terminal apparatus 300 is held at an inclination angle of θ° with respect to the horizontal direction. The center of gravity of the mobile terminal apparatus 300 is assumed to be in the center thereof. In this case, the force exerted on the thumb is Wg×(Y/2−D)/L×cos θ, where g is an acceleration of gravity. Where W=0.3, X=0.21, Y=0.3, L=0.04 and D=0.08, the force exerted on the thumb is 7.3N. If, as shown in FIG. 7B, the apparatus is supported, with the first and second fingers being apart from each other by K [m], then the radius r of curvature of the portion deformed by the thumb is given by the following:

$$\begin{matrix}r = EI / M \\ = E \times {Yh}^{3} / 12 \times 4 / PL \\ = E \times {Yh}^{3} / 3 / ( Wg \times ( Y / 2 - D ) / L \times cos θ ) / K\end{matrix}$$

Where W=0.3, X=0.21, Y=0.3, L=0.04, D=0.08 and K=0.05, the radius r of curvature is 0.27×E×h³.

In the above formula, E is an elastic modulus (Pa) of the mobile terminal apparatus 300, h is a thickness (m) of the mobile terminal apparatus 300, M is a bending moment of the mobile terminal apparatus 300, and I is a second moment of area of the mobile terminal apparatus 300. Based on the above formula, a radius-of-curvature threshold to be used in practice can be, for example, a value in the range of 0.2×E×h³ and 0.3×E×h³.

A method for setting an input rejection area will be described.

According to the present embodiment, the input rejection area is set in such a manner as to include a deformation position where the curvature is not less than the curvature threshold and is largest (the deformation position will be referred to as a maximal curvature position). FIG. 8 shows an example of an input rejection area set in the sensor area of the touch panel 101. In FIG. 8, the symbol “∘” indicates a maximal curvature position. The example shown in FIG. 8 corresponds to the case where the user holds the side portion of the mobile terminal apparatus with a hand, and the maximal curvature position detected on the side portion of the touch panel 10 is a position touched by the thumb. In this example, the input rejection area 801 is a rectangular area having a size of 30 mm×5 mm and including the maximal curvature position. The size of the input rejection area 801 can be 30 mm×5 mm, or greater, so that it can include a portion which is likely to be touched with the thumb of the user. The shape of the input rejection area is not limited to be a rectangular shape but may be any other shape desired. For example, the input rejection area determination unit 104 may set a circular area whose center is the maximal curvature position, as an input rejection area.

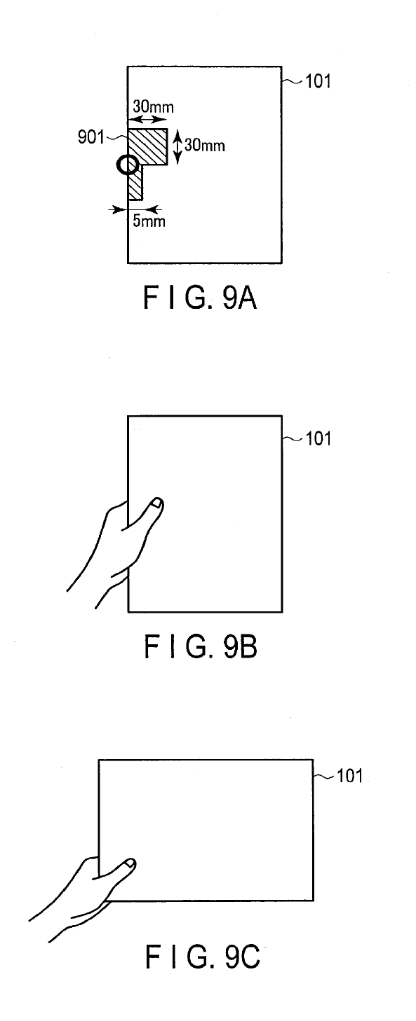

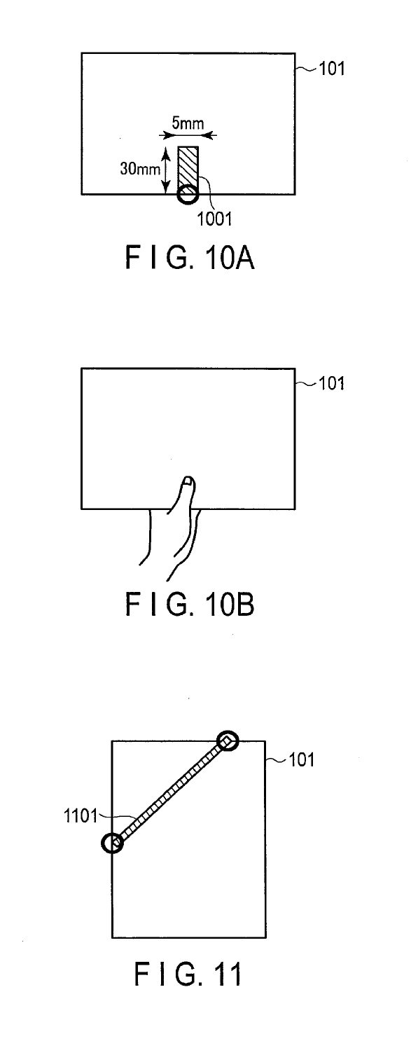

An example in which the shape of the input rejection area is changed in accordance with the position where the maximal curvature position is detected will be described with reference to FIGS. 9A to 10B. FIG. 9A shows an example of an input rejection area which is set in a case where a maximal curvature position is detected on a side portion of the touch panel 101. This example corresponds to the case where the mobile terminal apparatus provided with the touch panel 101 is held sideways with one hand, as shown in FIGS. 9B and 9C. In this case, the input rejection area 901 has a shape which is along the thumb holding the mobile terminal apparatus, for example, an “L” shape, as shown in FIG. 9A.

FIG. 10A shows an example of an input rejection area which is set in a case where a maximal curvature position is detected on a lower portion of the touch panel 101. This example corresponds to the case where the mobile terminal apparatus is held from below with one hand, as shown in FIG. 10B. In this case, the input rejection area 1001 has a shape which is along the thumb holding the mobile terminal apparatus, for example, a rectangular shape, as shown in FIG. 10A. The input rejection area is wider in the case where the mobile terminal apparatus is held sideways with one hand than in the case where it is held from below with one hand. The direction (or posture) in which the mobile terminal apparatus is held can be detected using an acceleration sensor (not shown). Since the shape of the input rejection area is changed in accordance with how the mobile terminal apparatus is held by the user, incorrect input can be effectively prevented.

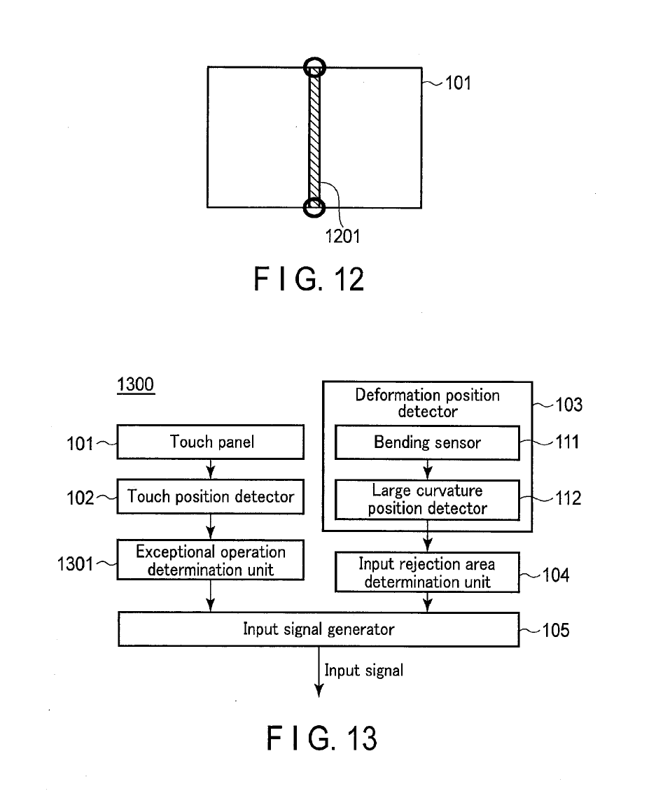

Another example of a method for setting an input rejection area will be described with reference to FIG. 11 and FIG. 12. FIGS. 11 and 12 show a case where a straight line connecting the maximal curvature position on one side and the maximal curvature position on another side is set as an input rejection area. In the example shown in FIG. 11, an input rejection area 1101 is set in such a manner as to connect the maximal curvature positions on the adjacent two sides of the touch panel 101. This example corresponds to the case where the mobile terminal apparatus (the touch panel 101) is held sideways with one hand, as shown in FIG. 9B. In the example shown in FIG. 12, an input rejection area 1201 is set in such a manner as to connect the maximal curvature positions on the opposite two sides of the touch panel 101. This example corresponds to the case where the mobile terminal apparatus is held from below with one hand, as shown in FIG. 10B. This method can be used if the bending sensor is arranged along two or more sides, but desirably the bending sensor 111 should be arranged along the four sides, as shown in FIG. 4A. Where the bending sensor 111 is arranged along the four sides of the sensor area, maximal curvature positions are detected on the respective four sides. From among these maximal curvature positions, maximal curvature positions corresponding to the largest and second largest values are selected, and a straight line connecting the selected two maximal curvature positions is set as an input rejection area. The width of the input rejection area may be about 5 mm, for example.

As described above, the input device of the first embodiment detects a position where the touch panel is deformed more than a threshold and sets an input rejection area based on that position. With this feature, incorrect input caused by the hand holding the apparatus is prevented.

In the input device 100 described above, no input is accepted in an input rejection area. However, a predetermined operation (which can be referred to as a gesture) may be excluded from input rejection targets as an exceptional operation. The exceptional operation is processed as an input even if it is detected in the input rejection area. An example in which the exceptional operation is determined will be described as a modification of the first embodiment.

FIG. 13 schematically shows an input device 1300 according to the modification of the first embodiment. The input device 1300 shown in FIG. 13 includes an exceptional operation determination unit 1301, in addition to the structural elements of the input device 100 shown in FIG. 1. The exceptional operation determination unit 1301 determines whether a user's operation is an exceptional operation, based on a detection signal supplied from the touch panel 101. Examples of the exceptional operation include a finger's long-distance movement, a finger's swift movement and a greatly changed curvature. For example, the operation of moving a finger on the sensor area at a speed more than a predetermined threshold is associated with an input for turning a page. Where the user operation is an exceptional operation, the input signal generator 105 generates an input signal from the operation, even if the operation is detected in the input rejection area.

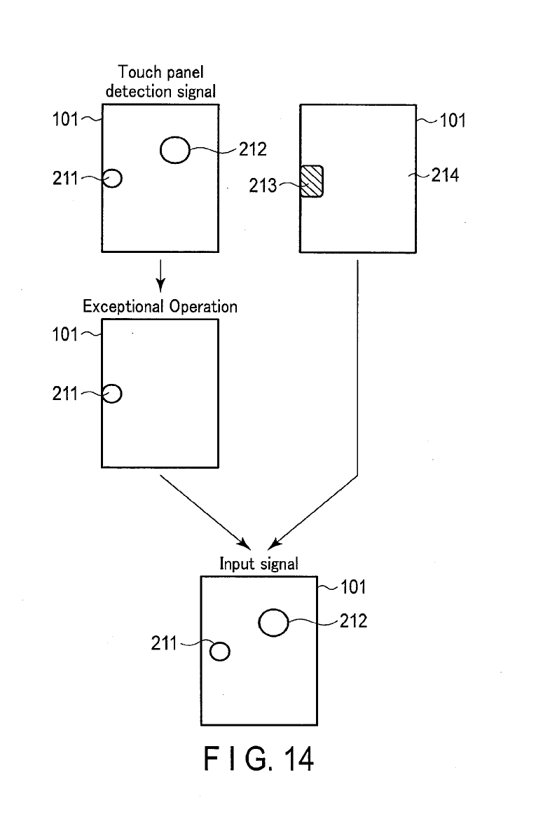

For example, the user holds the touch panel 101 with his or her left hand 201, as shown in FIG. 2A. The touch panel 101 deforms greatly at the portion held with the left hand 201. As a result, as shown in FIG. 14, a portion 213 corresponding to the touch 211 by the thumb of the left hand is set as an input rejection area. If, in this state, the user performs a touch operation with his or her right hand, two touches are detected, namely, the touch 211 by the left hand and the touch 212 by the right hand. The touch 211 is detected in the input rejection area 213. If this touch 211 is an exceptional operation, it is accepted as an input. In this way, an input signal is generated based on both touches 211 and 212. Since the exceptional operation is determined as above, an input can be entered with a finger holding the apparatus, with incorrect input being prevented. More specifically, when an electronic book is read or viewed, an input for turning a page can be entered by moving a finger holding the apparatus right and left. In this manner, the electronic book can be viewed with one hand in a stress-free state. In addition, various operations, including the enlargement/reduction of a map, the adjustment of sound volume and brightness, an operation of a game, fast-forward and fast-rewind of a video, can be performed using a finger holding the apparatus.

### Second Embodiment

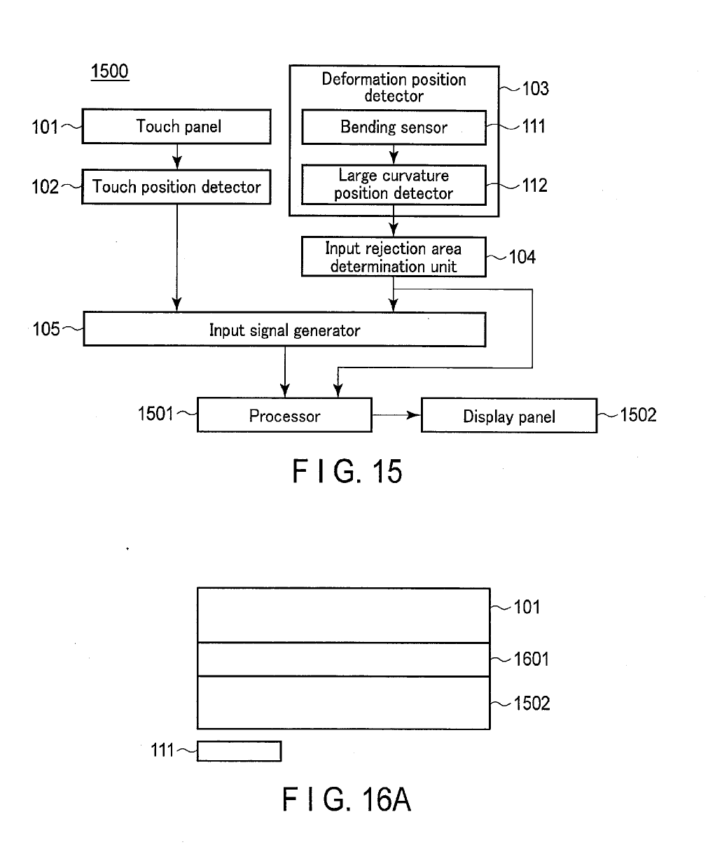

FIG. 15 schematically shows a display apparatus 1500 according to the second embodiment. The display apparatus 1500 shown in FIG. 15 includes the input device 100 shown in FIG. 1, a processor 1501 and a display panel 1502. The processor 1501 performs various kinds of processing based on an input signal generated by an input signal generator 105. The processor 1501 also generates an image signal corresponding to an image to be displayed on the display panel 1502. The processor 1501 receives information indicating an input rejection area from an input rejection area determination unit 104, and generates an image signal based on the received information so that an image can be displayed on the display panel 1502, except on the input rejection area. The display panel 1502 is, for example, a liquid crystal display or an organic EL display, and displays an image based on the image signal generated by the processor 1501.

When the mobile terminal apparatus provided with the touch panel 101 and the display panel 1502 is used, a hand holding the apparatus may overlap the display area, and the image portion covered with the hand cannot be viewed. In this case, the user has to hold the apparatus with the other hand to view the entire image. According to the present embodiment, an image can be displayed on the display panel 1502, except on the input rejection area, and the hand holding the apparatus does not have to be changed by the user.

The touch panel 101 is opposed to the display screen of the display panel 1502. From the standpoint of the display characteristics, the touch panel 101 is adhered to the display panel 1502 by means of an optically clear adhesive (OCA). The touch panel 101 need not be adhered to the display panel 1502.

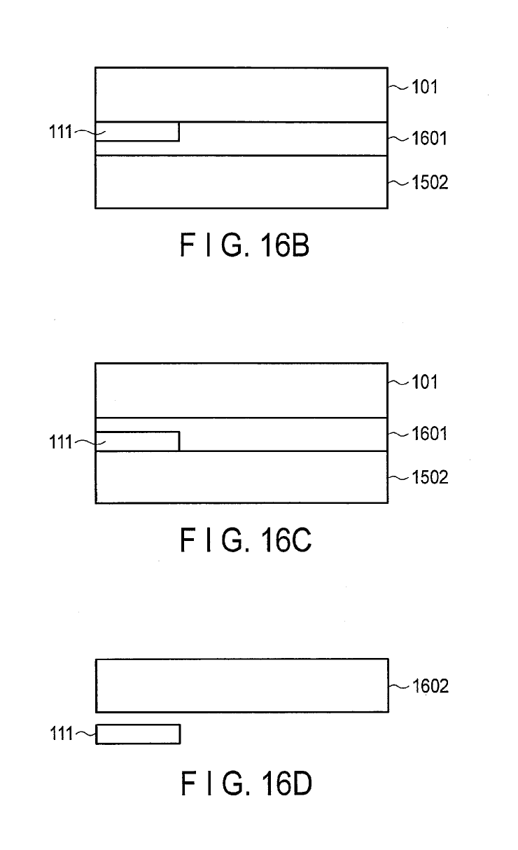

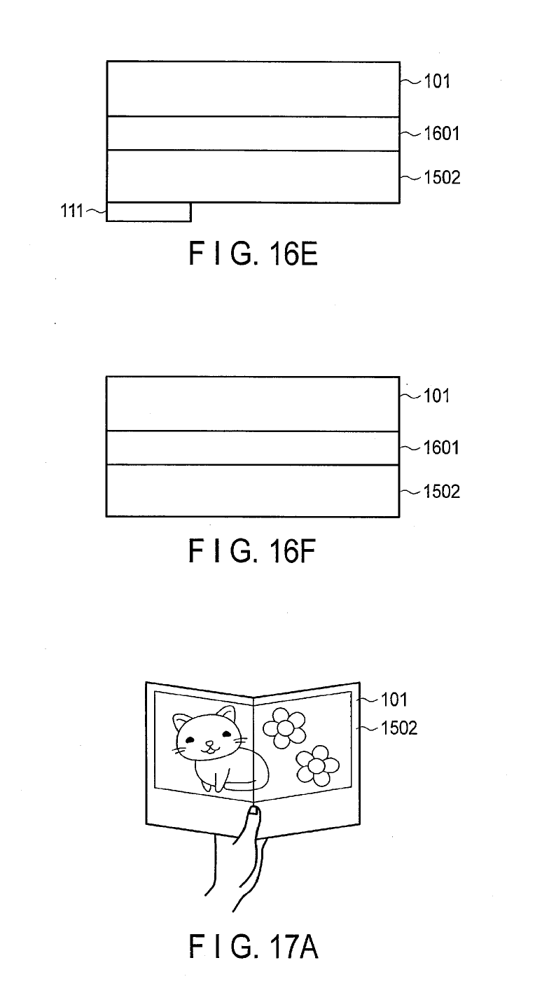

The bending sensor 111 may be provided either for the touch panel 101 or for the display panel 1502. The touch panel 101d and the display panel 1502 are adhered to each other by the optically clear adhesive 1601, as shown in FIG. 16A. In the example shown in FIG. 16A, the bending sensor 111 is attached to the casing of the mobile terminal at a position in the neighborhood of the display panel 1502. In the example shown in FIG. 16B, the bending sensor 111 is attached to the touch panel 101 at a position between the touch panel 101 and the display panel 1502. In the example shown in FIG. 16C, the bending sensor 111 is attached to the display panel 1502 at a position between the touch panel 101 and the display panel 1502. The touch panel 101 and the display panel 1502 may be integrally fabricated as a touch panel function-incorporated display 1602, as shown in FIG. 16D. In this case, the bending sensor 111 is opposed to the touch panel function-incorporated display 1602. In the example shown in FIG. 16E, the bending sensor 111 is electrically connected to part of the display panel 1502. In the example shown in FIG. 16F, the display panel 1502 includes a capacitive type bending sensor inside.

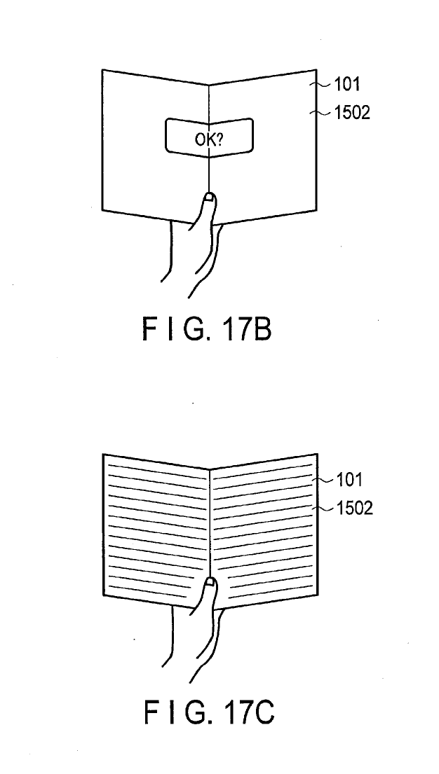

FIGS. 17A to 17C show examples in which an image is displayed except on an input rejection area. In the example shown in FIG. 17A, a rectangular area is extracted from the display screen in such a manner as not to include the input rejection area, and an image is displayed on the rectangular area. In the example shown in FIG. 17B, an important input item such as a dialogue is displayed at a position apart from the input rejection area. Accordingly, the hand holding the apparatus does not have to be changed by the user, and a pleasant input environment is ensured. In the example shown in FIG. 170, an image including text is displayed in such a manner as to avoid the input rejection area.

As described above, the display apparatus of the second embodiment has the same advantages as attained by the first embodiment, and is easy to operate since an image is displayed on the display in such a manner as to avoid the input rejection area.

### Third Embodiment

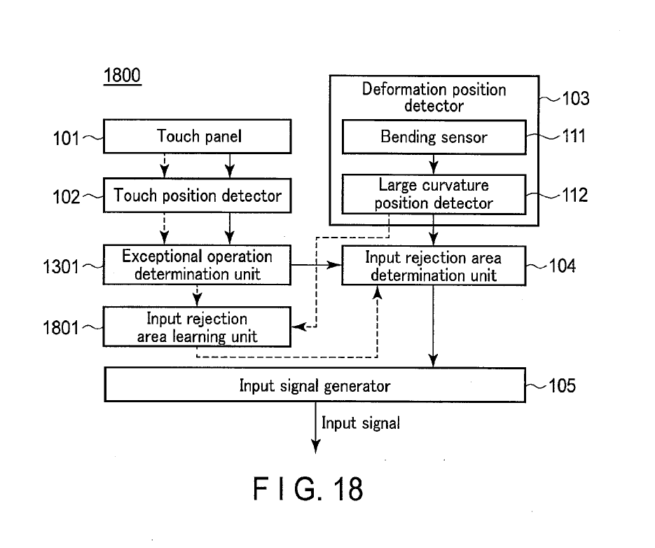

FIG. 18 schematically shows a display apparatus 1800 according to the third embodiment. The display apparatus 1800 shown in FIG. 18 includes, in addition to the structural elements of the display apparatus 1500 shown in FIG. 15, an input rejection area learning unit 1801 which learns an input rejection area based on a signal supplied from a touch panel 101 and a signal supplied from a deformation position detector 103. To be specific, the input rejection area learning unit 1801 learns how to determine an input rejection area, based on both a touch position detected by a touch position detector 102 and an input rejection area determined by an input rejection area determination unit 104. Information regarding an input rejection area, obtained by the learning by the input rejection area learning unit 1801, is supplied to the input rejection area determination unit 104.

According to the third embodiment, the decision algorithm of the input rejection area determination unit 104 is modified based on the learning information. As a result, the possibility of incorrect operations can be reduced further. The learning of the input rejection area may be performed in a state where a message such as “DO NOT OPERATE TOUCH PANEL” is displayed and the user is kept from touching the touch panel. The learning of the input rejection area may be performed without being conscious of by the user. In this case, a portion detected as a touch position and undergoing no change for more than a certain length of time is assumed to be a holding area, for example. In FIG. 18, the solid-line arrows indicate how signals are supplied in the normal operation mode, and the broken-line arrows indicate how signals are supplied in the learning mode of the input rejection area.

The input rejection area learning unit 1801 learns an input rejection area based on a holding area detected by the touch panel 101 and a deformation position detected by the deformation position detector 103. As a result, the determination accuracy of the input rejection area determination unit 104 can be enhanced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An input device comprising:
a flexible touch panel including a sensor area which is to be touched by an object;
a touch position detector which detects a touch position on the sensor area to generate a detection signal;
a deformation position detector which detects a deformation position where a deformation amount is not less than a threshold on the sensor area;
an input rejection area determination unit which determines, based on the deformation position, an input rejection area where an input is rejected on the sensor area; and
an input signal generator which processes the detection signal based on the touch position detected by the touch position detector and the input rejection area determined by the input rejection area determination unit, wherein the input signal generator fails to output the detection signal as an input signal if the touch position is detected in the input rejection area, and outputs the detection signal as an input signal if the touch position is detected in an area other than the input rejection area.

2. The input device according to claim 1, wherein the deformation position detector comprises:
a bending sensor which generates sensor signals in accordance with deformation amounts at positions on the touch panel; and
a large curvature position detector which calculates curvatures at the positions on the touch panel and detects, as the deformation position, a position whose curvature is not less than a curvature threshold.

3. The input device according to claim 2, wherein the bending sensor is arranged along at least part of an outer periphery of the sensor area.

4. The input device according to claim 1, wherein the input rejection area determination unit determines, as the input rejection area, an area including a position having a largest deformation amount in the sensor area, the largest deformation amount being not less than the threshold.

5. The input device according to claim 1, wherein the input rejection area determination unit changes a shape of the input rejection area in accordance with where on the touch panel the deformation position is detected.

6. The input device according to claim 2, wherein the deformation position detector detects a radius of curvature as the deformation amount and detects an area where the radius of curvature is 50 mm or less as the deformation position.

7. The input device according to claim 2, wherein the deformation position detector detects a radius of curvature as the deformation amount and detects, as the deformation position, an area where the radius of curvature is not more than a threshold, the threshold being determined based on a weight and a thickness of the input device.

8. The input device according to claim 1, further comprising an input rejection area learning unit which learns how to determine the input rejection area, based on the touch position detected by the touch position detector and the input rejection area determined by the input rejection area determination unit.

9. The input device according to claim 1, further comprising an exceptional operation determination unit which determines whether a user operation corresponding to the detection signal is an exceptional operation,
wherein, even where the input rejection area of the sensor area is touched, the input signal generator processes the detection signal determined to be the exceptional operation by the exceptional operation determination unit to generate the input signal.

10. A display apparatus comprising:
the input device according to claim 1; and
a display panel including a display screen opposed to the touch panel of the input device.

11. The display apparatus according to claim 10, further comprising an image signal generator which generates an image signal, wherein the image signal generator generates the image signal such that an image is displayed on the display screen, except on the input rejection area.

12. The display apparatus according to claim 11, wherein the image signal generator generates the image signal based on the input signal generated by the input signal generator.

13. A terminal apparatus comprising the input device according to claim 1.
